(19) United States
(12) Patent Application Publication
(10) Pub. No.: US 2020/0333428 A1
(43) Pub. Date: Oct. 22, 2020

(54) OPTICAL TRACKING SYSTEM AND TRAINING SYSTEM FOR MEDICAL EQUIPMENT

(71) Applicant: NATIONAL CHENG KUNG UNIVERSITY, Tainan City (TW)

(72) Inventors: Yung-Nien SUN, Tainan City (TW); I-Ming JOU, Tainan City (TW); Amy JU, Tainan City (TW); Ting-Li SHEN, Tainan City (TW); Chang-Yi CHIU, Tainan City (TW); Bo-Siang TSAI, Tainan City (TW)

(21) Appl. No.: 16/531,532

(22) Filed: Aug. 5, 2019

(30) Foreign Application Priority Data
Apr. 16, 2019 (TW) 108113268

(51) Int. Cl. G01S 5/16; G06T 17/00; G06T 19/20; G09B 9/00; G09B 19/24

(52) U.S. Cl. CPC G01S 5/16; G06T 17/00; G06T 19/20; G09B 23/28; G09B 19/24; G06T 2210/41; G06T 2219/2016; G09B 9/00

(57) ABSTRACT

An optical tracking system for a medical equipment includes optical markers, optical sensors and a computing device. The optical markers are disposed on the medical equipment. The optical sensors optically sense the optical markers to respectively generate sensing signals. The computing device is coupled to the optical sensors for receiving the sensing signals, and comprises a surgical situation 3-D model. The computing device is configured to adjust a relative position between a virtual medical equipment object and a virtual surgical target object in the surgical situation 3-D model according to the sensing signals.

### CROSS REFERENCE TO RELATED APPLICATIONS

This Non-provisional application claims priority under 35 U.S.C. § 119(a) on Patent Application No(s). 108113268 filed in Taiwan, Republic of China on Apr. 16, 2019, the entire contents of which are hereby incorporated by reference.

### BACKGROUND

### Technology Field

The present disclosure relates to an optical tracking system and a training system, and in particular, to an optical tracking system and a training system for a medical equipment.

### Description of Related Art

The operators usually need a lot of trainings for operating a medical equipment before applying to the real patients. In the case of minimally invasive surgery, in addition to operating the scalpel, the operator (e.g. surgeon) also operates the probe of ultrasound image equipment. The allowed error in the minimally invasive surgery is very small, and the operator usually needs a lot of experience to perform the operation smoothly. Thus, the pre-operative training is extraordinarily important.

Therefore, it is an important subject to provide an optical tracking system and training system for a medical equipment that can assist or train the users to operate the medical equipment.

### SUMMARY

In view of the foregoing, an objective of the present disclosure is to provide an optical tracking system and training system for a medical equipment that can assist or train the users to operate the medical equipment.

An optical tracking system for a medical equipment comprises a plurality of optical markers, a plurality of optical sensors, and a computing device. The optical markers are disposed on the medical equipment. The optical sensors optically sense the optical markers to respectively generate a plurality of sensing signals. The computing device is coupled to the optical sensors for receiving the sensing signals. The computing device comprises a surgical situation 3-D model, and is configured to adjust a relative position between a virtual medical equipment object and a virtual surgical target object in the surgical situation 3-D model according to the sensing signals.

In one embodiment, the optical tracking system comprises at least two optical sensors disposed above the medical equipment and toward the optical markers.

In one embodiment, the computing device and the optical sensors perform a pre-operation process. The pre-operation process comprises: calibrating a coordinate system of the optical sensors; and adjusting a zooming scale of the medical equipment and a surgical target object.

In one embodiment, the computing device and the optical sensors perform a coordinate calibration process, which comprises an initial calibration step, an optimization step, and a correcting step. The initial calibration step is to perform an initial calibration between a coordinate system of the optical sensors and a coordinate system of the surgical situation 3-D model to obtain an initial transform parameter. The optimization step is to optimize degrees of freedom of the initial transform parameter to obtain an optimum transform parameter. The correcting step is to correct a configuration error of the optimum transform parameter caused by the optical markers.

In one embodiment, the initial calibration step is performed by a method of singular value decomposition (SVD), triangle coordinate registration, or linear least square estimation.

In one embodiment, the initial calibration step utilizes a method of singular value decomposition to find a transform matrix between characteristic points of the virtual medical equipment object and the optical sensors as the initial transform parameter, the transform matrix comprises a covariance matrix and a rotation matrix, the optimization step obtains a plurality of Euler angles with multiple degrees of freedom from the rotation matrix and performs an iterative optimization of parameters with multiple degrees of freedom by Gauss-Newton algorithm so as to obtain the optimum transform parameter.

In one embodiment, the computing device sets positions of the virtual medical equipment object and the virtual surgical target object in the surgical situation 3-D model according to the optimum transform parameter and the sensing signals.

In one embodiment, the correcting step corrects positions of the virtual medical equipment object and the virtual surgical target object in the surgical situation 3-D model according to a reverse transform and the sensing signals.

In one embodiment, the computing device outputs visual data for displaying 3-D images of the virtual medical equipment object and the virtual surgical target object.

In one embodiment, the computing device generates a medical image according to the surgical situation 3-D model and a medical image model.

In one embodiment, the medical image is an artificial medical image of a surgical target object, and the surgical target object is an artificial limb.

In one embodiment, the computing device derives positions of the medical equipment inside and outside a surgical target object, and adjusts the relative position between the virtual medical equipment object and the virtual surgical target object in the surgical situation 3-D model according to the calculated positions.

A training system for operating a medical equipment comprises a medical equipment, and the above-mentioned optical tracking system for the medical equipment.

In one embodiment, the medical equipment comprises a medical detection tool and a surgical tool, and the virtual medical equipment object comprises a medical detection virtual tool and a surgical virtual tool.

In one embodiment, the computing device evaluates a score according to a process of utilizing the medical detection virtual tool to find a detected object and an operation of the surgical virtual tool.

A calibration method of an optical tracking system for a medical equipment comprises a sensing step, an initial calibration step, an optimization step, and a correcting step. The sensing step is to utilize a plurality of optical sensors of the optical tracking system to optically sensing a plurality of optical markers of the optical tracking system disposed on the medical equipment so as to generate a plurality of sensing signals, respectively. The initial calibration step is to perform an initial calibration between a coordinate system of the optical sensors and a coordinate system of a surgical situation 3-D model according to the sensing signals so as to obtain an initial transform parameter. The optimization step is to optimize degrees of freedom of the initial transform parameter to obtain an optimum transform parameter. The correcting step is to correct a configuration error of the optimum transform parameter caused by the optical markers.

In one embodiment, the calibration method further comprises a pre-operation process. The pre-operation process comprises: calibrating the coordinate system of the optical sensors; and adjusting a zooming scale of the medical equipment and a surgical target object.

In one embodiment, the initial calibration step is performed by a method of singular value decomposition, triangle coordinate registration, or linear least square estimation.

In one embodiment, the initial calibration step utilizes a method of singular value decomposition to find a transform matrix between characteristic points of a virtual medical equipment object of the surgical situation 3-D model and the optical sensors as the initial transform parameter, and the transform matrix comprises a covariance matrix and a rotation matrix. The optimization step obtains a plurality of Euler angles with multiple degrees of freedom from the rotation matrix and performs iterative optimization of parameters with multiple degrees of freedom by Gauss-Newton algorithm so as to obtain the optimum transform parameter.

In one embodiment, positions of the virtual medical equipment object and a virtual surgical target object in the surgical situation 3-D model are set according to the optimum transform parameter and the sensing signals. The correcting step corrects the positions of the virtual medical equipment object and the virtual surgical target object in the surgical situation 3-D model according to a reverse transform and the sensing signals.

As mentioned above, the optical tracking system of this disclosure can assist or train the users to operate the medical equipment, and the training system of this disclosure can provide the trainee with a realistic surgical training situation, thereby effectively assisting the trainee to complete the surgical training.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a block diagram showing an optical tracking system according to an embodiment of this disclosure;

FIGS. 1B and 1C are schematic diagrams showing the optical tracking system according to an embodiment of this disclosure;

FIG. 1D is a schematic diagram showing a surgical situation 3-D model according to an embodiment of this disclosure;

FIG. 2 is a flow chart of a pre-operation process of the optical tracking system according to an embodiment of this disclosure;

FIG. 3A is a flow chart of a coordinate calibration process of the optical tracking system according to an embodiment of this disclosure;

FIG. 3B is a schematic diagram of a coordinate system calibration according to an embodiment of this disclosure;

FIG. 3C is a schematic diagram of degrees of freedom according to an embodiment of this disclosure;

FIG. 4 is a block diagram of a training system for operating a medical equipment according to an embodiment of this disclosure;

FIG. 5A a schematic diagram showing a surgical situation 3-D model according to an embodiment of this disclosure;

FIG. 5B is a schematic diagram showing a physical medical image 3-D model according to an embodiment of this disclosure;

FIG. 5C is a schematic diagram showing an artificial medical image 3-D model according to an embodiment of this disclosure;

FIGS. 6A to 6D are schematic diagrams showing direction vectors of the medical equipment according to an embodiment of this disclosure;

FIGS. 7A to 7D are schematic diagrams showing the training procedure of the training system according to an embodiment of this disclosure;

FIG. 8A is a schematic diagram showing the structure of a finger according to an embodiment of this disclosure;

FIG. 8B is a schematic diagram showing an embodiment of performing the principal components analysis on the bone from the CT (computed tomography) images;

FIG. 8C is a schematic diagram showing an embodiment of performing the principal components analysis on the skin from the CT (computed tomography) images;

FIG. 8D is a schematic diagram showing an embodiment of calculating a distance between the bone axial and the medical equipment;

FIG. 8E is a schematic diagram showing an artificial medical image according to an embodiment of this disclosure;

FIG. 9A is a block diagram of generating an artificial medical image according to an embodiment of this disclosure;

FIG. 9B is a schematic diagram showing an artificial medical image according to an embodiment of this disclosure;

FIGS. 10A and 10B are schematic diagrams showing the hand phantom model and a calibration of ultrasound volume according to an embodiment of this disclosure;

FIG. 10C is a schematic diagram showing a ultrasound volume and a collision detection according to an embodiment of this disclosure; and

FIG. 10D is a schematic diagram showing an artificial ultrasound image according to an embodiment of this disclosure.

### DETAILED DESCRIPTION OF THE DISCLOSURE

The present disclosure will be apparent from the following detailed description, which proceeds with reference to the accompanying drawings, wherein the same references relate to the same elements.

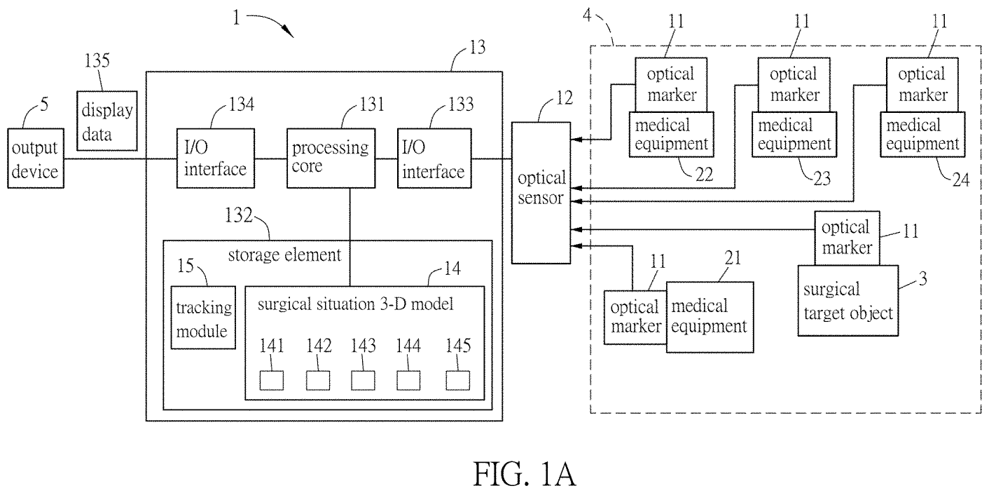

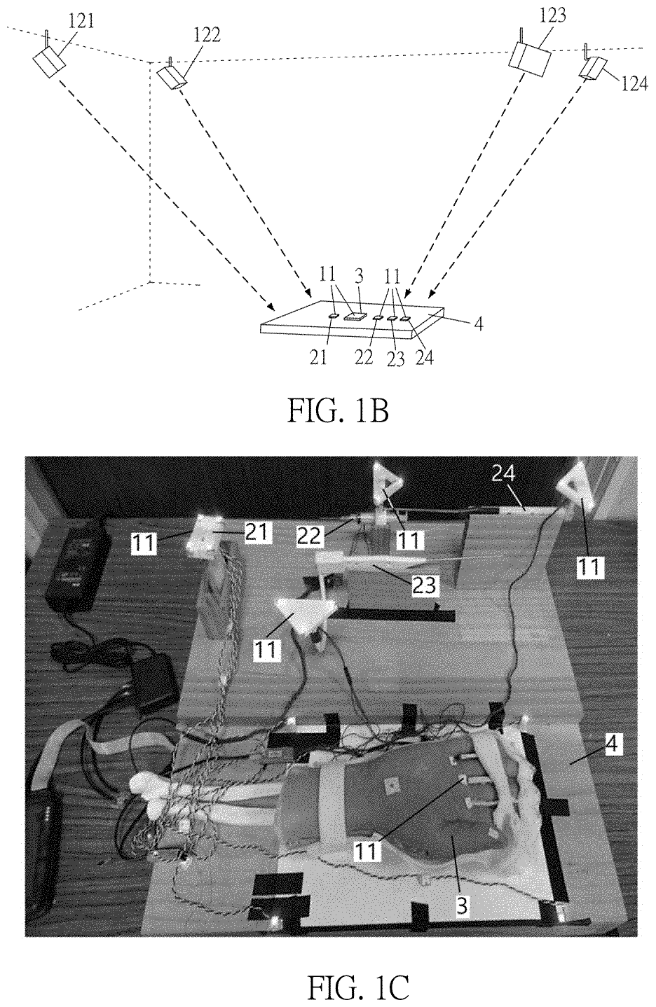

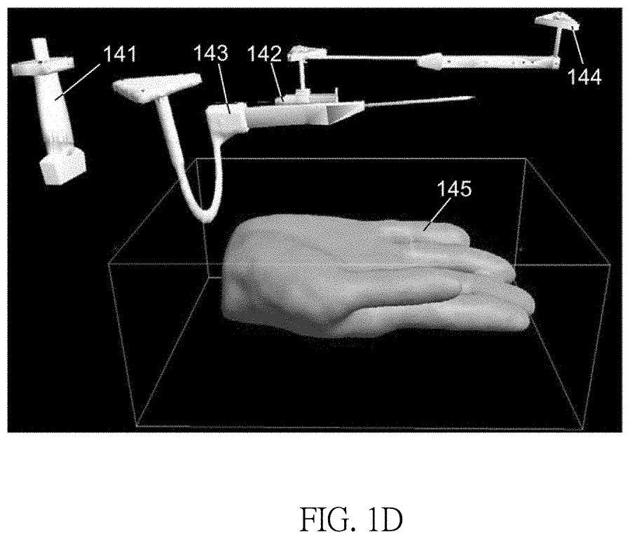

FIG. 1A is a block diagram showing an optical tracking system according to an embodiment of this disclosure. As shown in FIG. 1A, an optical tracking system 1 for a medical equipment comprises a plurality of optical markers 11, a plurality of optical sensors 12, and a computing device 13. The optical markers 11 are disposed on one or more medical equipment. In this embodiment, for example, the optical markers 11 are disposed on multiple medical equipment 21˜24. In addition, the optical markers 11 can also be disposed on a surgical target object 3, and the medical equipment 21˜24 and the surgical target object 3 are placed on a platform 4. The optical sensors 12 optically sense the optical markers 11 to respectively generate a plurality of sensing signals. The computing device 13 is coupled to the optical sensors 12 for receiving the sensing signals. The computing device 13 comprises a surgical situation 3-D model 14, and is configured to adjust a relative position between virtual medical equipment objects 141˜144 and a virtual surgical target object 145 in the surgical situation 3-D model 14 according to the sensing signals. Referring to FIG. 1D, the virtual medical equipment objects 141˜144 and the virtual surgical target object 145 represent the medical equipment 21˜24 and the surgical target object 3 in the surgical situation 3-D model 14. In the optical tracking system 1, the surgical situation 3-D model 14 can obtain the current positions of the medical equipment 21˜24 and the surgical target object 3, which can reflect to the virtual medical equipment object and the virtual surgical target object.

The optical tracking system 1 comprises at least two optical sensors 12, which are disposed above the medical equipment 21˜24 and toward the optical markers 11 for real-time tracking the medical equipment 21˜24 so as to obtain the positions thereof The optical sensors 12 can be camera-based linear detectors. FIG. 1B is a schematic diagram showing the optical tracking system according to an embodiment of this disclosure. For example, as shown in FIG. 1B, four optical sensors 121˜124 are installed on the ceiling and toward the optical markers 11, the medical equipment 21˜24 and the surgical target object 3 on the platform 4.

For example, the medical equipment 21 is a medical detection tool such as a probe for ultrasonic image detection or any device that can detect the internal structure of the surgical target object 3. These devices are used clinically, and the probe for ultrasonic image detection is, for example, an ultrasonic transducer. The medical equipment 22˜24 are surgical instruments such as needles, scalpels, hooks, and the likes, which are clinically used. If used for surgical training, the medical detection tool can be a clinically used device or a simulated virtual clinical device, and the surgical tool can also be a clinically used device or a simulated virtual clinical device. For example, FIG. 1C is a schematic diagram of an optical tracking system of an embodiment. As shown in FIG. 1C, the medical equipment 21-24 and the surgical target object 3 on the platform 4 are used for surgical training, such as finger minimally invasive surgery, which can be used for the trigger finger surgery. The platform 4 and the clippers of the medical equipment 21˜24 may be made of woody material. The medical equipment 21 is an immersive ultrasonic transducer (or probe), and the medical equipment 22˜24 include a plurality of surgical instruments, such as dilators, needles, and hook blades. The surgical target object 3 is a hand phantom. Each of the medical equipment 21˜24 is configured with three or four optical markers 11, and the surgical target object 3 is also configured with three or four optical markers 11. For example, the computing device 13 is connected to the optical sensors 12 for tracking the positions of the optical markers 11 in real time. In this embodiment, there are 17 optical markers 11, including 4 optical markers 11 located on or around the surgical target object 3 and moved relative to the surgical target object 3, and 13 optical markers 11 on the medical equipment 21˜24. The optical sensors 12 continuously transmits the real-time information to the computing device 13. In addition, the computing device 13 also uses the motion judging function to reduce the calculation loading. If the moving distance of the optical marker 11 is less than a threshold value, the position of the optical marker 11 is not updated. The threshold value is, for example, 0.7 mm.

Referring to FIG. 1A, the computing device 13 includes a processing core 131, a storage element 132, and a plurality of input and output (I/O) interfaces 133 and 134. The processing core 131 is coupled to the storage element 132 and the I/O interfaces 133 and 134. The I/O interface 133 can receive the sensing signals generated by the optical sensors 12, and the I/O interface 134 communicates with the output device 5. The computing device 13 can output the processing result to the output device 5 through the I/O interface 134. The I/O interfaces 133 and 134 are, for example, peripheral transmission ports or communication ports. The output device 5 is a device capable of outputting images, such as a display, a projector, a printer, and the likes.

The storage element 132 stores program codes, which can be executed by the processing core 131. The storage element 132 comprises the non-volatile memory and volatile memory. For example, the non-volatile memory can be a hard disk, a flash memory, a solid state disk, a compact disk, and the likes, and the volatile memory can be a dynamic random access memory, a static random access memory, or the likes. For example, the program codes are stored in the non-volatile memory, and the processing core 131 loads the program code from the non-volatile memory into the volatile memory and then executes the program code. The storage element 132 stores the program codes and data of the surgical situation 3-D model 14 and the tracking module 15. The processing core 131 can access the storage element 132 to execute and process the program codes and data of the surgical situation 3-D model 14 and the tracking module 15.

The processing core 131 can be, for example, a processor, a controller, or the likes. The processor may comprise one or more cores. The processor can be a central processing unit or a graphics processing unit, and the processing core 131 can also be the core of a processor or a graphics processor. On the other hand, the processing core 131 can also be a processing module, and the processing module comprises a plurality of processors.

The operation of the optical tracking system includes a connection between the computing device 13 and the optical sensors 12, a pre-operation process, a coordinate calibration process of the optical tracking system, a rendering process, and the likes. The tracking module 15 represents the relevant program codes and data of these operations. The storage element 132 of the computing device 13 stores the tracking module 15, and the processing core 131 executes the tracking module 15 to perform these operations.

The computing device 13 can perform the pre-operation and the coordinate calibration of the optical tracking system to find the optimum transform parameter, and then the computing device 13 can set positions of the virtual medical equipment objects 141˜144 and the virtual surgical target object 145 in the surgical situation 3-D model 14 according to the optimum transform parameter and the sensing signals. The computing device 13 can derive the positions of the medical equipment 21 inside and outside a surgical target object 3, and adjusts the relative position between the virtual medical equipment object 141˜144 and the virtual surgical target object 145 in the surgical situation 3-D model 14. Accordingly, the medical equipment 21˜24 can be real-time tracked from the detection result of the optical sensors 12 and correspondingly presented in the surgical situation 3-D model 14. The virtual objects (representations) in the surgical situation 3-D model 14 are as shown in FIG. 1D.

The surgical situation 3-D model 14 is a native model, which comprises the model established for the surgical target object 3 as well as the model established for the medical equipment 21˜24. For example, the developer can establish the model on a computer by computer graphic technology. In practice, the user may operate a graphic software or a specific software to establish the models.

The computing device 13 can output the visual data 135 to the output device 5 for displaying 3-D images of the virtual medical equipment objects 141˜144 and the virtual surgical target object 145. The output device 5 can output the visual data 135 by displaying, printing, or the likes. FIG. 1D shows that the visual data 135 is outputted by displaying.

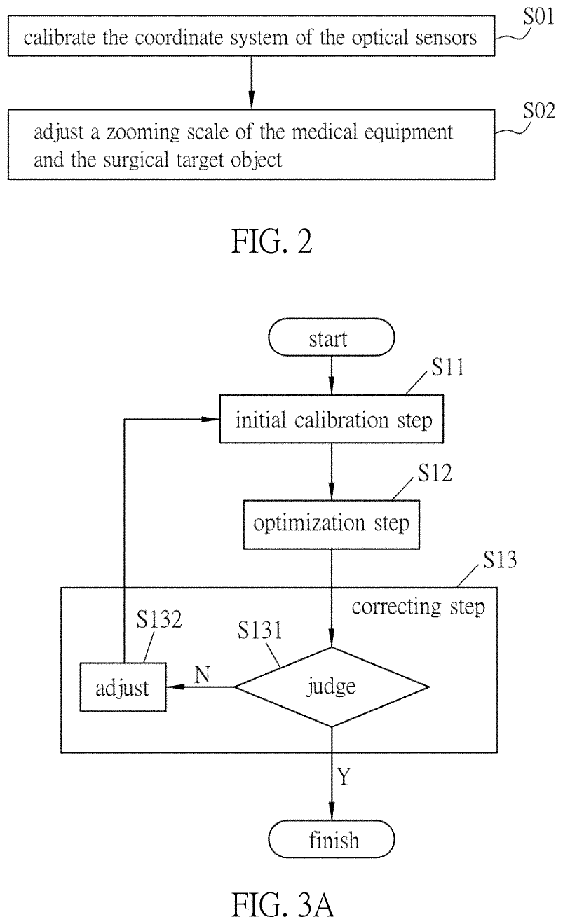

FIG. 2 is a flow chart of a pre-operation process of the optical tracking system according to an embodiment of this disclosure. As shown in FIG. 2, the computing device 13 and the optical sensors 12 perform a pre-operation process, which comprises steps S01 and S02, for calibrating the optical sensors 12 and readjusting the zooming scale of all medical equipment 21˜24.

The step S01 is to calibrate the coordinate system of the optical sensors 12. In detailed, a plurality of calibration sticks carrying a plurality of optical markers are provided, and the calibration sticks travel around or surround an area to define a working area. The optical sensors 12 sense the optical markers on the calibration sticks. When the optical sensors 12 sense all of the optical markers, the area which is traveled around or surrounded by the calibration sticks is defined as an effective working area. The calibration sticks are disposed manually by the user, so the user can adjust the positions of the calibration sticks to modify the effective working area. The sensitivity of the optical sensor 12 can be about 0.3 mm. In this embodiment, the coordinate system of the detection result of the optical sensors 12 is also named as a tracking coordinate system.

The step S02 is to adjust a zooming scale of the medical equipment 21˜24 and the surgical target object 3. Generally, the medical equipment 21˜24 are rigid bodies, so the coordinate calibration adopts the rigid body calibration for preventing distortion. Accordingly, the medical equipment 21˜24 must be rescaled to the tracking coordinate system for obtaining the correct calibration result. The scaling ratio can be calculated based on the following equation:

$$MeshToTrackingRatio = \frac{{\sum }_{i}^{markerNum} \frac{( {Track}_{G} - {Track}_{i} )}{( {Mesh}_{G} - {Mesh}_{i} )}}{markerNum}$$

$${Track}_{G} = \frac{{\sum }_{i}^{markerNum} {Track}_{i}}{markerNum}$$

$${Mesh}_{G} = \frac{{\sum }_{i}^{markerNum} {Mesh}_{i}}{markerNum}$$

Track_{G}: the center of gravity in the tracking coordinate system
Trackᵢ: the positions of the optical markers in the tracking coordinate system
Mesh_{G}: the center of gravity in the mesh dot coordinate system
Meshᵢ: the positions of the optical markers in the mesh dot coordinate system

The detection result of the optical sensors 12 adopts the tracking coordinate system, and the surgical situation 3-D model 14 adopts the mesh dot coordinate system. The step S02 is to calculate the centers of gravity in the tracking coordinate system and the mesh dot coordinate system, and then to calculate the distances between the centers of gravity and the optical markers in the tracking coordinate system and the mesh dot coordinate system. Afterwards, the individual ratios of the mesh dot coordinate system to the tracking coordinate system are obtained, and all of the individual ratios are summed and divided by the number of optical markers, thereby obtaining the ratio of the mesh dot coordinate system to the tracking coordinate system.

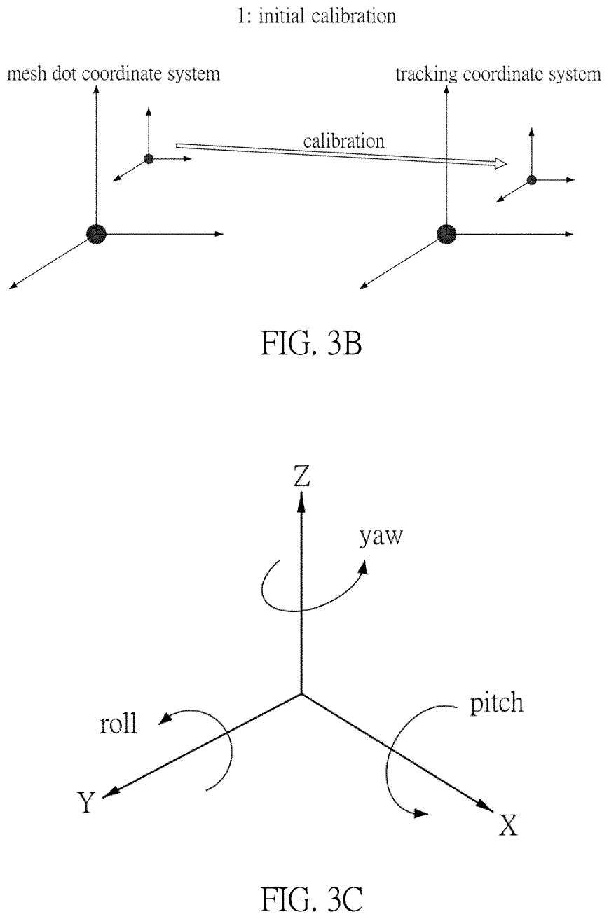

FIG. 3A is a flow chart of a coordinate calibration process of the optical tracking system according to an embodiment of this disclosure. As shown in FIG. 3A, the computing device and the optical sensors perform a coordinate calibration process, which comprises an initial calibration step S11, an optimization step S12, and a correcting step S13. The initial calibration step S11 is to perform an initial calibration between the coordinate system of the optical sensors 12 and the coordinate system of the surgical situation 3-D model 14 to obtain an initial transform parameter. The calibration between the coordinate systems can be referred to FIG. 3B. The optimization step S12 is to optimize degrees of freedom of the initial transform parameter to obtain an optimum transform parameter. The degrees of freedom can be referred to FIG. 3C. The correcting step S13 is to correct a configuration error of the optimum transform parameter caused by the optical markers.

Since the tracking coordinate system can be transformed to the coordinate system of the surgical situation 3-D model 14, the optical markers attached to the platform 4 can be used to calibrate these two coordinate systems.

The initial calibration step S11 is to find a transform matrix between characteristic points of a virtual medical equipment objects and the optical sensors as the initial transform parameter. Herein, the initial calibration step is performed by a method of singular value decomposition, triangle coordinate registration, or linear least square estimation. The transform matrix comprises, for example, a covariance matrix and a rotation matrix.

For example, the initial calibration step S11 utilizes a method of singular value decomposition to find an optimum transform matrix between characteristic points of a virtual medical equipment objects 141˜144 and the optical sensors as the initial transform parameter. The covariance matrix H can be obtained from the characteristic points, and it can be the objective function to be optimized. The rotation matrix M can be found by the following equations:

$$P = [ \begin{matrix}x \\ y \\ z\end{matrix} ] ;$$

$${centroid}_{A} = \frac{1}{N} {\sum }_{i = 1}^{N} {P}_{A}^{i} ;$$

$${centroid}_{B} = \frac{1}{N} {\sum }_{i = 1}^{N} {P}_{B}^{i}$$

$$H = {\sum }_{i = 1}^{N} ( {P}_{A}^{i} - {centroid}_{A} ) {( {P}_{B}^{i} - {centroid}_{B} )}^{T} \\ [ U , Σ , V ] = SVD ( H ) ; M = {VU}^{T}$$

After obtaining the rotation matrix M, the translation matrix T can be obtained according to the following equation:

T=−M×centroid_{A}+centroid_{B}

The optimization step S12 obtains a plurality of Euler angles with multiple degrees of freedom from the rotation matrix M and performs iterative optimization of parameters with multiple degrees of freedom by Gauss-Newton algorithm so as to obtain the optimum transform parameter. The multiple degrees of freedom can be, for example, six degrees of freedom or any of other numbers of degrees of freedom (e.g. nine degrees of freedom), and, of course, it is also possible to properly modify the equations. Since the transform result obtained by the initial calibration step S11 may not be precise enough, the optimization step S12 can be performed to improve the preciseness so as to obtain a more precise transform result.

Assuming that γ represents an angle with respect to the X axis, α represents an angle with respect to the Y axis, and β represents an angle with respect to the Z axis, the rotation of each axis of the world coordinates can be expressed as follows:

$$M = [ \begin{matrix}{m}_{11} & {m}_{12} & {m}_{13} \\ {m}_{21} & {m}_{21} & {m}_{23} \\ {m}_{31} & {m}_{32} & {m}_{33}\end{matrix} ]$$

$${m}_{11} = cos αcos β$$

$${m}_{12} = sin γ sin α cos β - cos γ sin β$$

$${m}_{13} = cos γ sin α cos β + sin γ sin β$$

$${m}_{21} = cos α sin β$$

$${m}_{22} = sin γ sin α sin β + cos γ cos β$$

$${m}_{23} = cos γ sin α sin β - sin γ cos β$$

$${m}_{31} = - sin α$$

$${m}_{32} = sin γ cos α$$

$${m}_{33} = cos γ cos α$$

The rotation matrix M can be obtained from the above equation. In general, the multiple Euler angles can be obtained according to the following equations:

γ=atan 2(m₃₂,m₃₃)

α=atan 2(−m₃₁,{square root over (m₁₁²+m₂₁²))}

β=atan 2(sin(γ)m₁₃−cos(γ)m₁₂,cos(γ)m₂₂−sin(γ)m₂₃)

After obtaining the Euler angles, assuming that the rotation of the world coordinate system is an orthogonal rotation, the obtained parameter with six degrees of freedom can be performed with iterative optimization by Gauss-Newton algorithm so as to obtain the optimum transform parameter. E(q\vec{ }) is the objective function to be minimized.

$$E ( \vec{q} ) = {\sum }_{i = 1}^{3 \times n} {b}_{i}^{2}$$

$$b = [ \begin{matrix}{b}_{1} \\ ⋮ \\ {b}_{3 \times n}\end{matrix} ] = [ \begin{matrix}{x}_{1} - {x}_{1}^{′} \\ {y}_{1} - {y}_{1}^{′} \\ {z}_{1} - {z}_{1}^{′} \\ \\ {z}_{n} - {z}_{n}^{′}\end{matrix} ]$$

Wherein, b represents the least square errors between the reference target point and the current point, and n is the number of the characteristics points, q\vec{ } is the transformation parameter which has translation and rotation parameters. The transformation parameter is performed with the iterative optimization by Gauss-Newton algorithm so as to adjust and obtain the optimum value. The updated function of the transformation parameter q\vec{ } is as follows:

$$\vec{q} ( t + 1 ) = \vec{q} ( t ) + Δ \\ Δ is a Jacobian matrix from the target function . \\ Δ = {( {J}^{T} J )}^{- 1} {J}^{T} b$$

$$J = {[ \begin{matrix}\frac{\partial {b}_{1} ( \vec{q} )}{\partial {q}_{1}} & ⋯ & \frac{\partial {b}_{3 \times n} ( \vec{q} )}{\partial {q}_{1}} \\ ⋮ & ⋱ & ⋮ \\ \frac{\partial {b}_{1} ( \vec{q} )}{\partial {q}_{6}} & ⋯ & \frac{\partial {b}_{3 \times n} ( \vec{q} )}{\partial {q}_{6}}\end{matrix} ]}_{6 \times 3 \times n}$$

The stop condition is define as follow:

E( [symbol] (t))−E( [symbol] (t+1))<10⁻⁸

The correcting step S13 is to correct a configuration error of the optimum transform parameter caused by the optical markers. The correcting step S13 comprises a judging step S131 and an adjusting step S132.

In the step S13, the correcting process for source characteristic points can overcome the error caused by manual selecting characteristic points. In detailed, the error is generated when the user manually selecting the characteristic points of the virtual medical equipment objects 141˜144 and the virtual surgical target object 145 in the surgical situation 3-D model and the characteristic points of the medical equipment 21˜24 and the surgical target object 3. The characteristic points of the medical equipment 21˜24 and the surgical target object 3 comprise the configuration points of the optical markers 11. Since the optimum transformation can be obtained from the step S12, the target position obtained by n times of iterative transformation from the source point can approach the reference target point as V_{T} follow:

VₛⁿT_{target←source}ⁿ=\hat{V}_{T}ⁿ≈V_{T}
T_{target←source}ⁿ: the transform matrix of the nth iteration from the source point to the target point
Vₛⁿ: the source point of the nth iteration
\hat{V}_{T}ⁿ: the target point after n iterative transformations

The source point correcting step is to calculate the inversion of the transform matrix, and then to obtain a new source point from the reference target point. The calculation is as follows:

V_{s′}ⁿ=V_{T}ⁿ(T_{target←source}ⁿ)⁻¹
(T_{target←source}ⁿ)⁻¹: inversion of the transform matrix
V_{s′}ⁿ: the new source point after n iterative inverse transformations
V_{T}ⁿ: the target point after n iterative inverse transformations

Assuming the transformation of the two coordinate systems is exactly as mentioned above, after n iterations, the new source point will be an ideal position of an original source point. However, there is a displacement between the original source point and the ideal source point. In order to minimize the manual selection error by calibrating the original source point, each iteration can set a constraint step size c₁ and a constraint region box size c₂, which can be constant values, for restricting the moving distance of the original source point. The calibration equation is as follow:

$${V}_{s}^{n + 1} = {V}_{s}^{n} + min ( {c}_{1} \cdot \frac{{V}_{{s}^{′}}^{n} - {V}_{s}^{n}}{‖ {V}_{{s}^{′}}^{n} - {V}_{s}^{n} ‖} , {V}_{{s}^{′}}^{n} - {V}_{s}^{n} ) , {c}_{1} = 2$$

$${\vert {V}_{s}^{n + 1} - {V}_{s}^{0} \vert}_{l} < {c}_{2} , {c}_{2} = 5 , l = x , y , z$$

In each iteration, if the distance between the two points is less than c₁, the source point will move to a new point, otherwise the source point will only move for a length c1 toward the new point. If the condition of the following equation occurs, the iteration will be aborted. V_{T} is the transformed target point from the source point V_{S}.

∥\hat{V}_{T}ⁿ⁺¹−\hat{V}_{T}ⁿ∥<10⁻⁵

By the calibration of the aforementioned three steps, the coordinate position of the surgical situation 3-D model 14 can be accurately transformed to the corresponding optical marker 11 in the tracking coordinate system, and vice versa. Thereby, the medical equipment 21˜24 and the surgical target object 3 can be tracked in real-time based on the detection result of the optical sensors 12, and the positions of the medical equipment 21˜24 and the surgical target object 3 in the tracking coordinate system are processed through the aforementioned processing, thereby correspondingly showing the virtual medical equipment objects 141˜144 and the virtual surgical target object 145 in the surgical situation 3-D model 14. When the medical equipment 21˜24 and the surgical target object 3 physically move, the virtual medical equipment objects 141˜144 and the virtual surgical target object 145 will correspondingly move in the surgical situation 3-D model 14 in real-time.

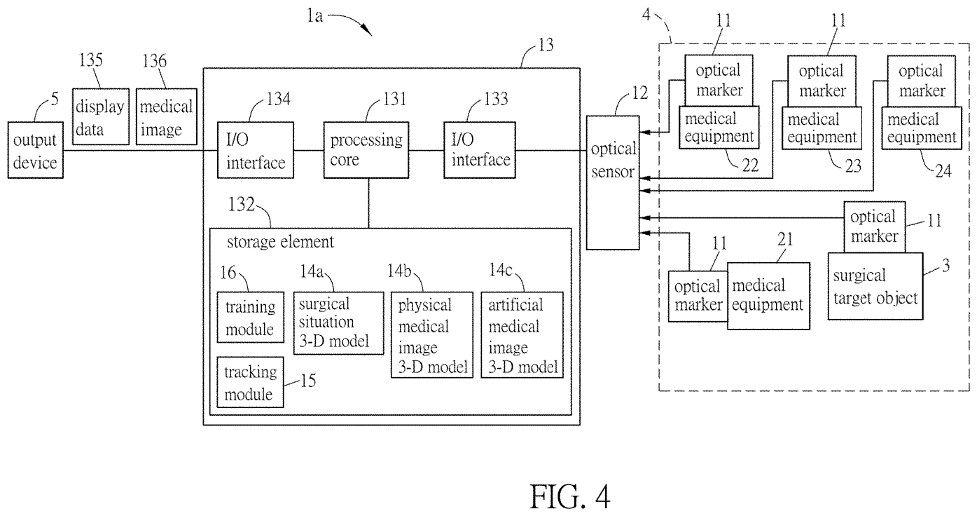

FIG. 4 is a block diagram of a training system for operating a medical equipment according to an embodiment of this disclosure. A training system for operating a medical equipment can realistically simulate a surgical training situation. The training system comprises an optical tracking system 1a, one or more medical equipment 21˜24, and a surgical target object 3. The optical tracking system 1a includes a plurality of optical markers 11, a plurality of optical sensors 12, and a computing device 13. The optical markers 11 are disposed on the medical equipment 21˜24 and the surgical target object 3, and the medical equipment 21˜24 and the surgical target object 3 are placed on the platform 4. For the medical equipment 21˜24 and the surgical target object 3, the virtual medical equipment objects 141˜144 and the virtual surgical target object 145 are correspondingly presented in the surgical situation 3-D model 14a. The medical equipment 21˜24 include medical detection tools and surgical tools. For example, the medical equipment 21 is a medical detection tool (probe), and the medical equipment 22˜24 are surgical tools. The virtual medical equipment objects 141˜144 include medical detection virtual tools and surgical virtual tools. For example, the virtual medical equipment object 141 is a medical detection virtual tool, and the virtual medical equipment objects 142˜144 are surgical virtual tools. The storage element 132 stores the program codes and data of the surgical situation 3-D model 14a and the tracking module 15. The processing core 131 can access the storage element 132 to execute and process the program codes and data of the surgical situation 3-D model 14a and the tracking module 15. The implementations and variations of the corresponding elements having the same reference numbers in the above description and related drawings may be referred to the description of the above embodiment, and thus will not be described again.

The surgical target object 3 can be an artificial limb, such as upper limb phantom, hand phantom, palm phantom, finger phantom, arm phantom, upper arm phantom, forearm phantom, elbow phantom, upper limb phantom, feet phantom, toes phantom, ankles phantom, calves phantom, thighs phantom, knees phantom, torso phantom, neck phantom, head phantom, shoulder phantom, chest phantom, abdomen phantom, waist phantom, hip phantom or other phantom parts, etc.

In this embodiment, the training system is applied for training, for example, the minimally invasive surgery of finger. In this case, the surgical target object 3 is a hand phantom, and the surgery is, for example, a trigger finger surgery. The medical equipment 21 is an immersive ultrasonic transducer (or probe), and the medical equipment 22˜24 are a needle, a dilator, and a hook blade. In other embodiments, the surgical target object 3 can be different parts for performing other surgery trainings.

The storage element 132 further stores the program codes and data of a physical medical image 3-D module 14b, an artificial medical image 3-D module 14c, and a training module 16. The processing core 131 can access the storage element 132 to execute and process the program codes and data of the physical medical image 3-D module 14b, the artificial medical image 3-D module 14c, and the training module 16. The training module 16 responses for performing the following surgery training procedures and the processing, integrating and calculating of the related data.

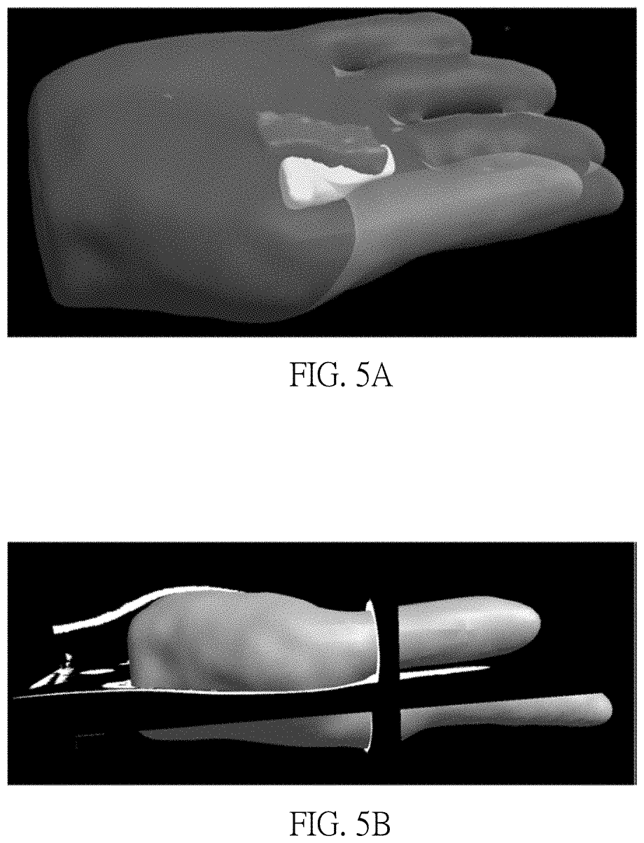

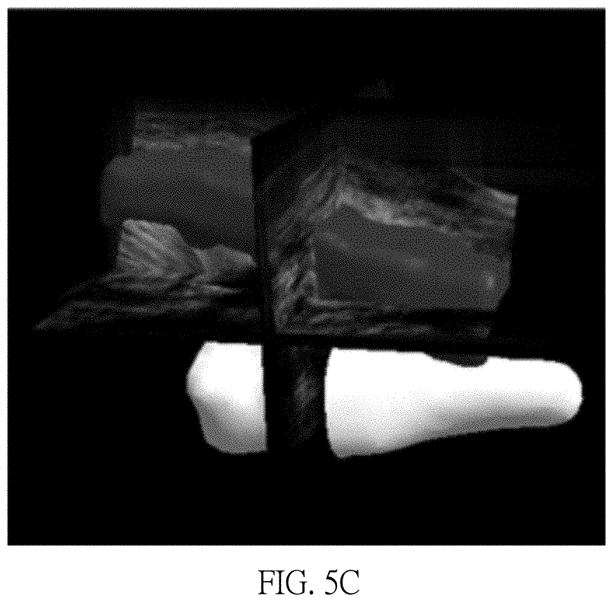

The image model for surgery training is pre-established and imported into the system prior to the surgery training process. Taking the finger minimally invasive surgery as an example, the image model includes finger bones (palm and proximal phalanx) and flexor tendon. These image models can refer to FIGS. 5A to 5C. FIG. 5A a schematic diagram showing a surgical situation 3-D model according to an embodiment of this disclosure, FIG. 5B is a schematic diagram showing a physical medical image 3-D model according to an embodiment of this disclosure, and FIG. 5C is a schematic diagram showing an artificial medical image 3-D model according to an embodiment of this disclosure. The contents of these 3-D models can be outputted or printed by the output device 5.

The physical medical image 3-D model 14b is a 3-D model established from the medical image, and it is established for the surgical target object 3 (e.g. the 3-D model of FIG. 5B). The medical images can be, for example, the CT (computed tomography) images, which is obtained by subjecting the surgical target object 3 to the computed tomography. The obtained CT images can be used to establish the physical medical image 3-D model 14b.

The artificial medical image 3-D model 14c contains an artificial medical image model, which is established for the surgical target object 3, such as the 3-D model as shown in FIG. 5C. For example, the artificial medical image model is a 3-D model of an artificial ultrasound image. Since the surgical target object 3 is not a real life body, the computed tomography can obtain a physical structural images, but other medical image equipment such as ultrasonic image equipment cannot obtain the effective or meaningful images directly from the surgical target object 3. Therefore, the ultrasonic image model of the surgical target object 3 must be produced in an artificial manner. In practice, an appropriate position or plane is selected from the 3-D model of the artificial ultrasound image so as to generate a 2-D artificial ultrasound image.

The computing device 13 generates a medical image 136 according to the surgical situation 3-D model 14a and the medical image model. The medical image model is, for example, the physical medical image 3-D model 14b or the artificial medical image 3-D model 14c. For example, the computing device 13 generates a medical image 136 according to the surgical situation 3-D model 14a and the artificial medical image 3-D model 14c. Herein, the medical image 136 is a 2-D artificial ultrasound image. The computing device 13 evaluates a score according to a process of utilizing the medical detection virtual tool 141 to find a detected object and an operation of the surgical virtual tool 145. Herein, the detected object is, for example, a specific surgical site.

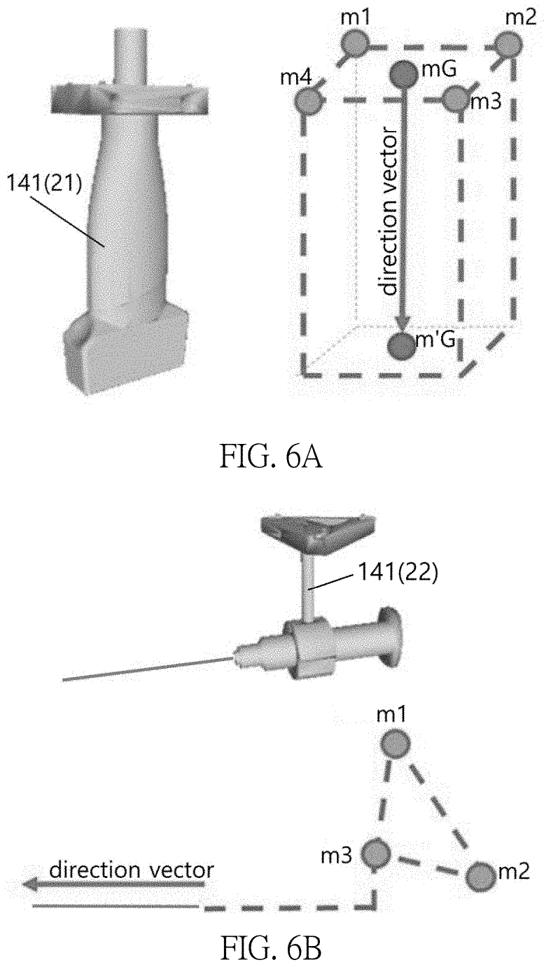

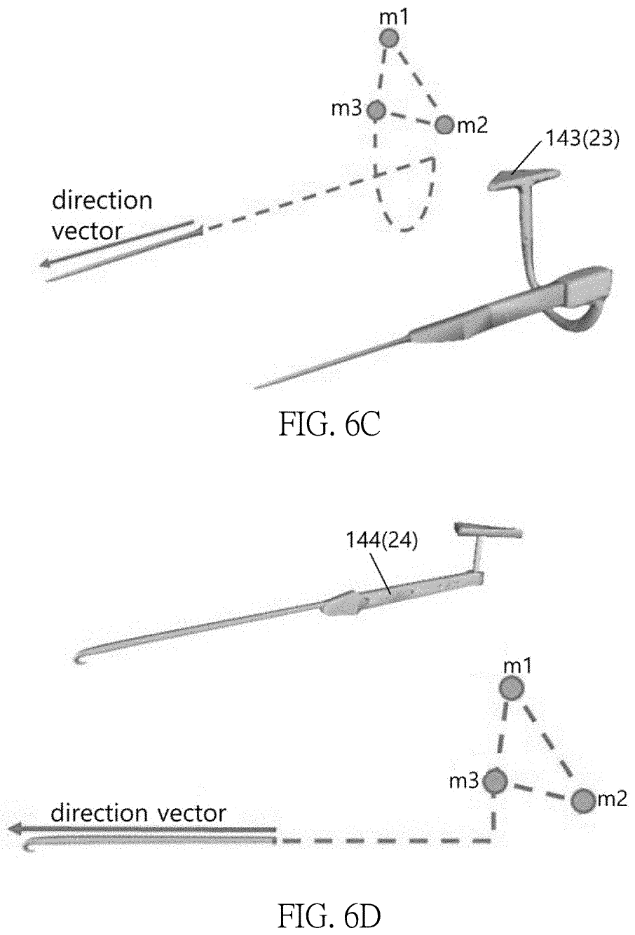

FIGS. 6A to 6D are schematic diagrams showing direction vectors of the medical equipment according to an embodiment of this disclosure. The direction vectors of the virtual medical equipment objects 141˜144 corresponding to the medical equipment 21˜24 can be rendered in real-time. Regarding the virtual medical equipment object 141, the direction vector of the medical detection tool can be obtained by calculating the center of weight of the optical marker, and another point is projected to the x-z plane so as to calculate the vector from the center of weight to the projection point. Regarding the other virtual medical equipment objects 142˜144 (simpler cases), the direction vectors thereof can be calculated by the sharp points in the model.

In order to reduce the system loading and avoid delays, the amount of image depiction can be reduced. For example, the training system can only draw the model in the area where the virtual surgical target object 145 is located rather than all of the virtual medical equipment objects 141˜144.

In the training system, the transparency of the skin model can be adjusted to observe the anatomy inside the virtual surgical target object 145, and to view an ultrasound image slice or a CT image slice of a different cross section, such as a horizontal plane (axial plane), a sagittal plane, or coronal plane. This configuration can help the surgeon during the operation. The bounding boxes of each model are constructed for collision detection. The surgery training system can determine which medical equipment has contacted the tendons, bones and/or skin, and can determine when to start evaluation.

Before the calibration process, the optical markers 11 attached to the surgical target object 3 must be clearly visible or detected by the optical sensor 12. The accuracy of detecting the positions of the optical markers 11 will decrease if the optical markers 11 are shielded. The optical sensor 12 needs to sense at least two whole optical markers 11. The calibration process is as described above, such as a three-stage calibration, which is used to accurately calibrate two coordinate systems. The calibration error, the iteration count, and the final positions of the optical markers can be displayed in a window of the training system, such as the monitor of the output device 5. Accuracy and reliability information can be used to alert the user that the system needs to be recalibrated when the error is too large. After the coordinate system calibration is completed, the 3-D model is drawn at a frequency of 0.1 times per second, and the rendered result can be output to the output device 5 for displaying or printing.

After preparing the training system, the user can start the surgery training procedure. In the training procedure, the first step is to operate the medical detection tool to find the surgery site, and then the site will be anesthetized. Afterward, the path from the outside to the surgery site is expanded, and then the scalpel can reach the surgery site through the expanded path.

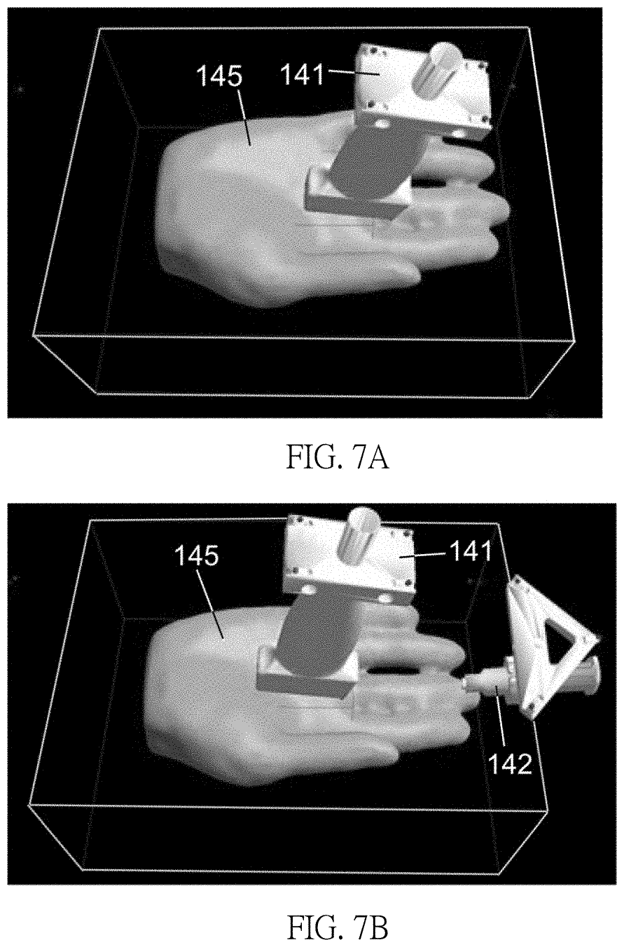

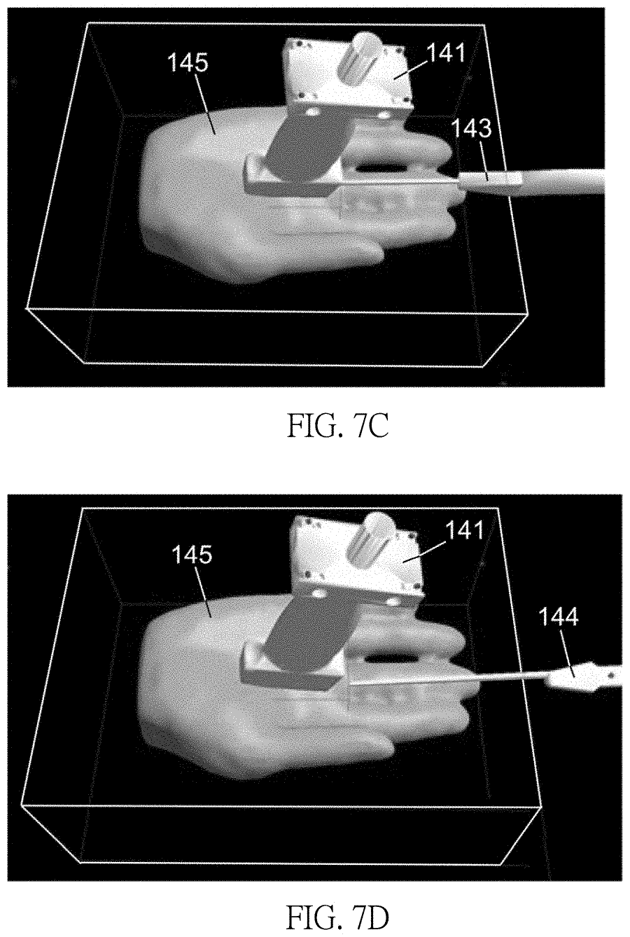

FIGS. 7A to 7D are schematic diagrams showing the training procedure of the training system according to an embodiment of this disclosure.

As shown in FIG. 7A, in the first stage, the medical detection tool 21 is used to find the surgery site to confirm that the site is within the training system. The surgery site is, for example, a pulley, which can be judged by finding the positions of the metacarpal joints (MCP joints), the bones of the fingers, and the anatomy of the tendon. The point of this stage is whether the first pulley (A1 pulley) is found or not. In addition, if the trainee does not move the medical detection tool for more than three seconds to determine the position, then the training system will automatically proceed to the evaluation of next stage. During the surgical training, the medical detection tool 21 is placed on the skin and remained in contact with the skin at metacarpal joints (MCP joints) on the midline of the flexor tendon.

As shown in FIG. 7B, in the second stage, the surgical equipment 22 is used to open the path of the surgical field, and the surgical equipment 22 is, for example, a needle. The needle is inserted to inject a local anesthetic and expand the space, and the insertion of the needle can be performed under the guidance of a continuous ultrasound image. This continuous ultrasound image is an artificial ultrasound image, such as the aforementioned medical image 136. Because it is difficult to simulate local anesthesia of a hand phantom, no special simulation of anesthesia is conducted.

As shown in FIG. 7C, in the third stage, the surgical equipment 23 is pushed along the same path as the surgical equipment 22 in the second stage to create the trace required for the hook blade in the next stage. The surgical equipment 23 is, for example, a dilator. In addition, if the trainee does not move the surgical equipment 23 for more than three seconds to determine the position, then the training system will automatically proceed to the evaluation of the next stage.

As shown in FIG. 7D, in the fourth stage, the surgical equipment 24 is inserted along the trace created in the third stage, and the pulley is divided by the surgical equipment 24, such as a hook blade. The point of the fourth stage is similar to that of the third stage. During the surgery training, the vessels and nerves along the two sides of the flexor tendon may be easily cut unintentionally, so the key points of the third and fourth stages are to not contact the tendons, nerves and vessels, and to open a trace that is at least 2 mm over the first pulley, thereby leaving the space for the hook blade to cut the pulley.

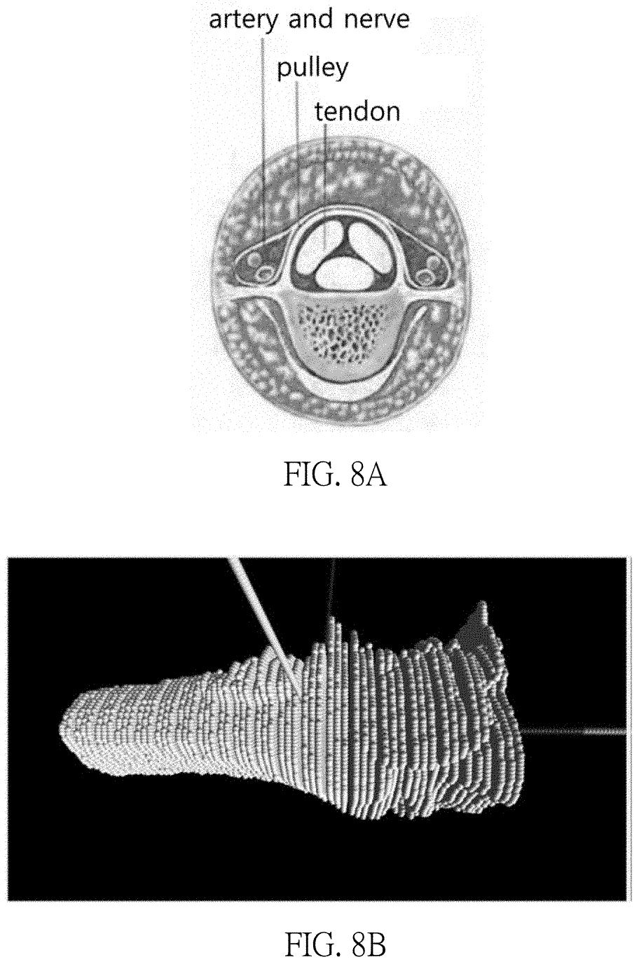

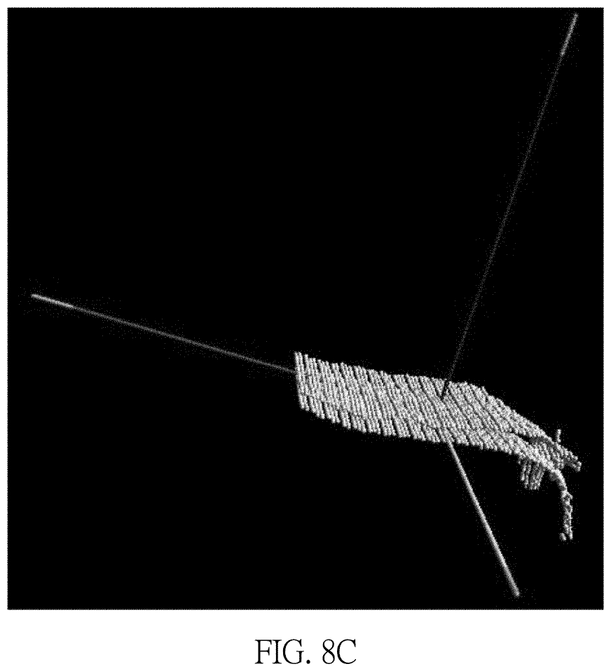

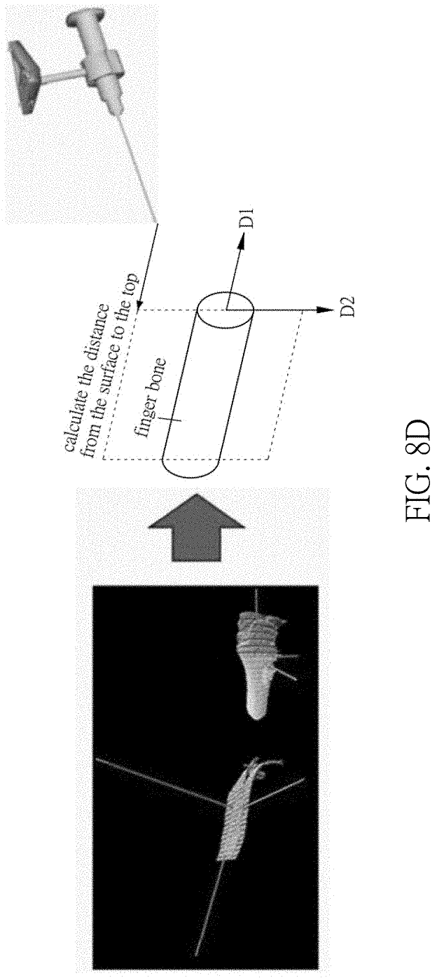

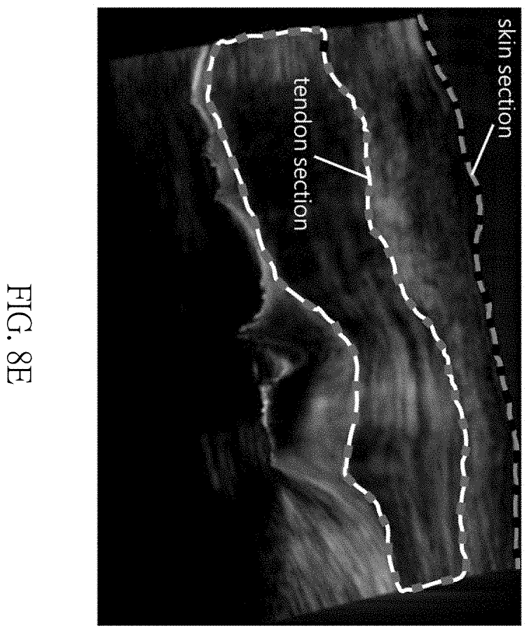

In order to evaluate the operation of the user, the operation of each training stage must be quantified. First, the surgical field in operation is defined by the finger anatomy of FIG. 8A, which can be divided into an upper boundary and a lower boundary. Since most of the tissues around the tendon are fat, it does not cause pain. Thus, the upper boundary of the surgical field can be defined by the skin of the palm, and the lower boundary can be defined by the tendon. The proximal depth boundary is 10 mm (average length of the first pulley) from the metacarpal head-neck joint. The distal depth boundary is not important because it is not associated with damages of tendon, vessels and nerves. The left and right boundaries are defined by the width of the tendon, and the nerves and vessels are located at two sides of the tendon.

After defining the surgical field, the evaluating method for each training stage is as follows. In the first stage of FIG. 7A, the point of the training is to find the target, for example, the object to be cut. Taking the finger as an example, the A1 pulley is the object to be cut. In the actual surgery procedure, in order to obtain the good ultrasound image quality, the angle between the medical detection tool and the main axis of bone should be close to vertical, and the allowable angular deviation is ±30°. Therefore, the equation of evaluating the first stage is as follow:

score of first stage=(score for finding the object)×(weight)+(score of the angle of medical detection tool)×(weight)

In the second stage of FIG. 7B, the point of the training is to use a needle to open the path of the surgical field. Since the pulley surrounds the tendon, the distance between the main axis of bone and the needle should be as small as better. Therefore, the equation of evaluating the second stage is as follow:

score of second stage=(score for opening the path)×(weight)+(score of the angle of needle)×(weight)+(score of the distance from main axis of bone)×(weight)

In the third stage, the point of the training is to insert the dilator into the finger for enlarging the surgical field. During the surgery, the trace of the dilator must be close to the main axis of bone. In order to not damage the tendon, vessels and nerves, the dilator does not exceed the boundaries of the previously defined surgical field. In order to properly expand the trace for the surgical field, the angle between the dilator and the main axis of bone is preferably approximately in parallel with an allowable angular deviation of ±30°. The dilator must be at least 2 mm over the first pulley for leaving the space for the hook blade to cut the first pulley. The equation of evaluating the third stage is as follow:

score of third stage=(score of over the pulley)×(weight)+(score of the angle of dilator)×(weight)+(score of the distance from main axis of bone)×(weight)+(score of not leaving the surgical field)×(weight)

In the fourth stage, the evaluation conditions of the fourth stage is similar to that of the third stage. Different from the third stage, the evaluation of rotating the hook blade for 90° must be added to the evaluation of the fourth stage. The equation of evaluating the fourth stage is as follow:

score of third stage=(score of over the pulley)×(weight)+(score of the angle of hook blade)×(weight)+(score of the distance from main axis of bone)×(weight)+(score of not leaving the surgical field)×(weight)+(score of rotating the hook blade)×(weight)

In order to establish the evaluating standards to evaluate the surgery operation of a user, it is necessary to define how to calculate the angle between the main axis of bone and the medical equipment. For example, this calculation is the same as calculating the angle between the palm normal and the direction vector of the medical equipment. First, the main axis of bone must be found. As shown in FIG. 8B, the three axes of the bone can be found by using Principal Components Analysis (PCA) on the bone from the computed tomography images. Among the three axes, the longest axis is taken as the main axis of bone. However, in computed tomography images, the shape of the bone is uneven, which causes that the palm normal and the axis found by PCA are not perpendicular to each other. Thus, as shown in FIG. 8C, instead of using PCA on the bone, the skin on the bone can be used to find the palm normal by using PCA. The angle between the main axis of bone and the medical equipment can then be calculated.

After calculating the angle between the main axis of bone and the medical equipment, it is also needed to calculate the distance between the main axis of bone and the medical equipment. This distance calculation is similar to calculating the distance between the top of the medical equipment and the plane. The plane refers to the plane containing the main axis of bone and the palm normal. The distance calculation is shown in FIG. 8D. This plane can be obtained by the cross product of the vector D2 of the palm normal and the vector D1 of the main axis of bone. Since these two vectors can be calculated in the previous calculation, the distance between the main axis of bone and the medical equipment can be easily calculated.

FIG. 8E is a schematic diagram showing an artificial medical image according to an embodiment of this disclosure, wherein the tendon section and the skin section in the artificial medical image are indicated by dotted lines. As shown in FIG. 8E, the tendon section and the skin section can be used to construct the model and the bounding box. The bounding box is used for collision detection, and the pulley can be defined in the static model. By using the collision detection, it is possible to determine the surgical field and judge whether the medical equipment crosses the pulley or not. The average length of the first pulley is approximately 1 mm. The first pulley is located at the proximal end of the MCP head-neck joint. The average thickness of the pulley surrounding the tendon is approximately 0.3 mm.

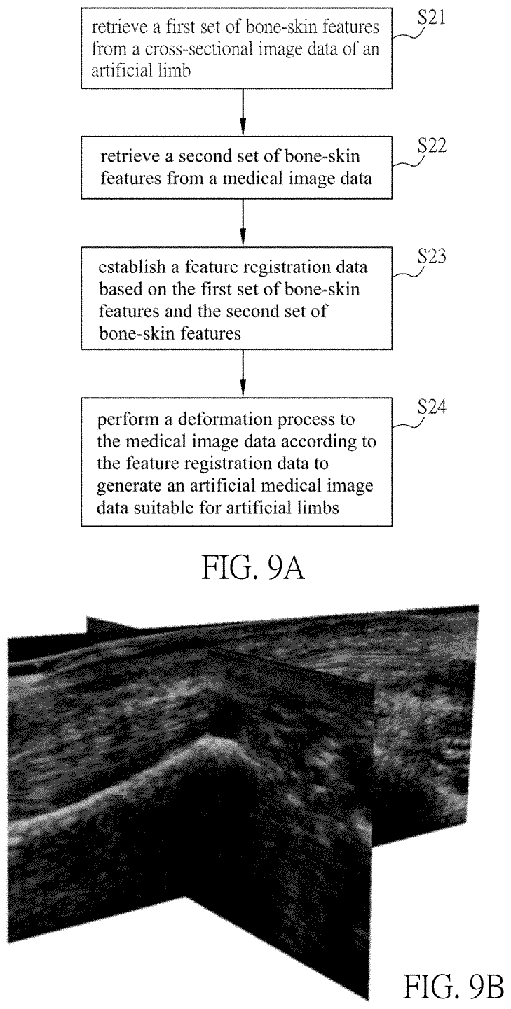

FIG. 9A is a block diagram of generating an artificial medical image according to an embodiment of this disclosure. As shown in FIG. 9A, the generating procedure comprises the steps S21 to S24.

The step S21 is to retrieve a first set of bone-skin features from a cross-sectional image data of an artificial limb. The artificial limb is the aforementioned surgical target object 3, which can be used as a limb for minimally invasive surgery training, such as a hand phantom. The cross-sectional image data contain multiple cross-sectional images, and the cross-sectional reference images are computed tomography images or physical cross-sectional images.

The step S22 is to retrieve a second set of bone-skin features from a medical image data. The medical image data is a stereoscopic ultrasound image, such as the stereoscopic ultrasound image of FIG. 9B, which is established by a plurality of planar ultrasound images. The medical image data is a medical image taken of a real creature instead of an artificial limb. The first set of bone-skin features and the second set of bone-skin features comprise a plurality of bone feature points and a plurality of skin feature points.

The step S23 is to establish a feature registration data based on the first set of bone-skin features and the second set of bone-skin features. The step S23 comprises: taking the first set of bone-skin features as the reference target; and finding a correlation function as the spatial correlation data, wherein the correlation function satisfies that when the second set of bone-skin features aligns to the reference target, there is no interference caused by the first set of bone-skin features and the second set of bone-skin features. The correlation function is found through the algorithm of the maximum likelihood estimation problem and the EM algorithm.

The step S24 is to perform a deformation process to the medical image data according to the feature registration data to generate an artificial medical image data suitable for artificial limbs. The artificial medical image data is, for example, a stereoscopic ultrasound image that maintains the features of the organism within the original ultrasound image. The step S24 comprises: generating a deformation function according to the medical image data and the feature registration data; applying a grid to the medical image data to obtain a plurality of mesh dot positions; deforming the mesh dot positions according to the deformation function; and generating a deformed image by adding corresponding pixels from the medical image data based on the deformed mesh dot positions, wherein the deformed image is used as the artificial medical image data. The deformation function is generated by moving least square (MLS). The deformed image is generated by using the affine transform.

In the steps S21 to S24, the image features are retrieved from the real ultrasound image and the computed tomography image of hand phantom, and the corresponding point relationship of the deformation is obtained by the image registration. Afterward, an artificial ultrasound image which is like an ultrasound image of human is generated by the deformation based on the hand phantom, and the generated ultrasound image can maintain the features in the original real ultrasound image. In the case that the artificial medical image data is a stereoscopic ultrasonic image, a plane ultrasonic image of a specific position or a specific slice surface can be generated according to a position or a slice surface corresponding to the stereoscopic ultrasonic image.

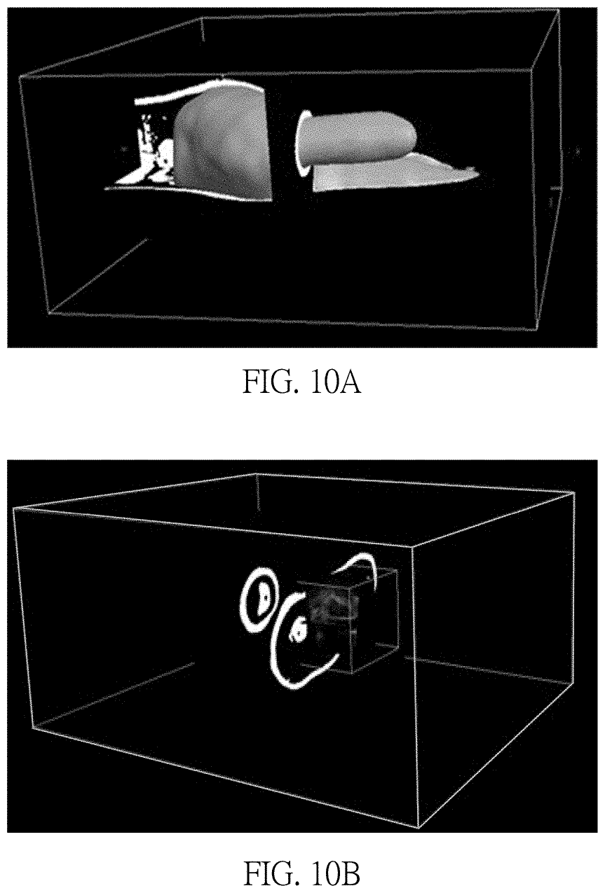

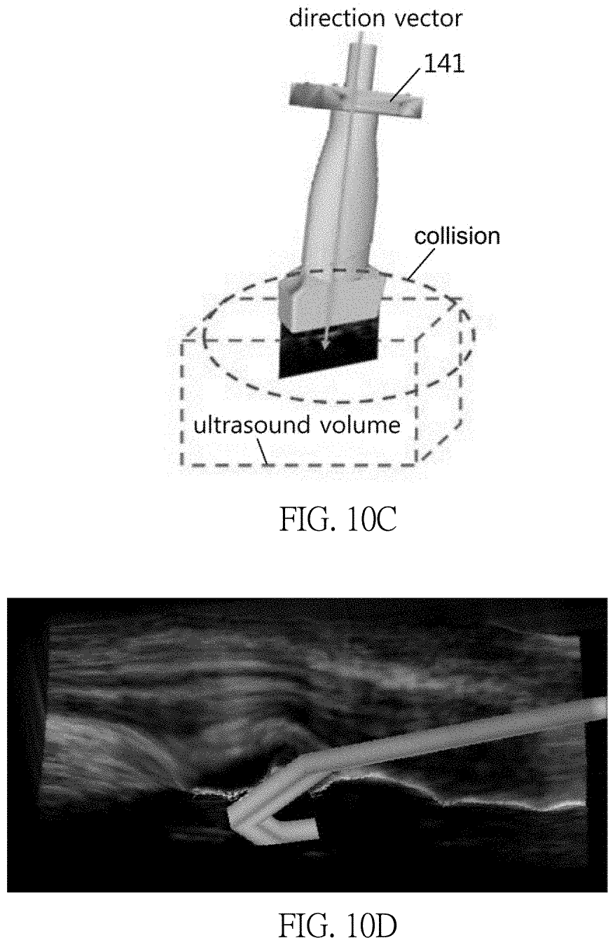

FIGS. 10A and 10B are schematic diagrams showing the hand phantom model and a calibration of ultrasound volume according to an embodiment of this disclosure. As shown in FIGS. 10A and 10B, the physical medical image 3-D model 14b and the artificial medical image 3-D model 14c are related to each other. Since the model of the hand phantom is constructed by the computed tomography image volume, the positional relationship between the computed tomography image volume and the ultrasonic volume can be directly used to create the relationship between the hand phantom and the ultrasound volume.

FIG. 10C is a schematic diagram showing a ultrasound volume and a collision detection according to an embodiment of this disclosure, and FIG. 10D is a schematic diagram showing an artificial ultrasound image according to an embodiment of this disclosure. As shown in FIGS. 10C and 10D, the training system is capable of simulating a real ultrasonic transducer (or probe) so as to produce a sliced image segment from the ultrasound volume. The simulated transducer (or probe) must depict the corresponding image segment regardless of the transducer (or probe) at any angle. In practice, the angle between the medical detection tool 21 and the ultrasonic body is first detected. Then, the collision detection of the segment surface is based on the width of the medical detection tool 21 and the ultrasonic volume, which can be used to find the corresponding value of the image segment being depicted. The generated image is shown in FIG. 10D. For example, if the artificial medical image data is a stereoscopic ultrasonic image, the stereoscopic ultrasonic image has a corresponding ultrasonic volume, and the content of the image segment to be drawn by the simulated transducer (or probe) can be generated according to the corresponding position of the stereoscopic ultrasonic image.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. An optical tracking system for a medical equipment, comprising:
a plurality of optical markers disposed on the medical equipment;
a plurality of optical sensors optically sensing the optical markers to respectively generate a plurality of sensing signals; and
a computing device coupled to the optical sensors for receiving the sensing signals, wherein the computing device comprises a surgical situation 3-D model, and is configured to adjust a relative position between a virtual medical equipment object and a virtual surgical target object in the surgical situation 3-D model according to the sensing signals.

2. The system of claim 1, wherein the optical tracking system comprises at least two of the optical sensors disposed above the medical equipment and toward the optical markers.

3. The system of claim 1, wherein the computing device and the optical sensors perform a pre-operation process, and the pre-operation process comprises:
calibrating a coordinate system of the optical sensors; and
adjusting a zooming scale of the medical equipment and a surgical target object.

4. The system of claim 1, wherein the computing device and the optical sensors perform a coordinate calibration process, and the coordinate calibration process comprises:
an initial calibration step for performing an initial calibration between a coordinate system of the optical sensors and a coordinate system of the surgical situation 3-D model to obtain an initial transform parameter;
an optimization step for optimizing degrees of freedom of the initial transform parameter to obtain an optimum transform parameter; and
a correcting step for correcting a configuration error of the optimum transform parameter caused by the optical markers.

5. The system of claim 4, wherein the initial calibration step is performed by a method of singular value decomposition (SVD), triangle coordinate registration, or linear least square estimation.

6. The system of claim 4, wherein the initial calibration step utilizes a method of singular value decomposition to find a transform matrix between characteristic points of the virtual medical equipment object and the optical sensors as the initial transform parameter, the transform matrix comprises a covariance matrix and a rotation matrix, the optimization step obtains a plurality of Euler angles with multiple degrees of freedom from the rotation matrix and performs an iterative optimization of parameters with multiple degrees of freedom by Gauss-Newton algorithm so as to obtain the optimum transform parameter.

7. The system of claim 4, wherein the computing device sets positions of the virtual medical equipment object and the virtual surgical target object in the surgical situation 3-D model according to the optimum transform parameter and the sensing signals.

8. The system of claim 4, wherein the correcting step corrects positions of the virtual medical equipment object and the virtual surgical target object in the surgical situation 3-D model according to a reverse transform and the sensing signals.

9. The system of claim 1, wherein the computing device outputs visual data for displaying 3-D images of the virtual medical equipment object and the virtual surgical target object.

10. The system of claim 1, wherein the computing device generates a medical image according to the surgical situation 3-D model and a medical image model.

11. The system of claim 10, wherein the medical image is an artificial medical image of a surgical target object, and the surgical target object is an artificial limb.

12. The system of claim 1, wherein the computing device calculates positions of the medical equipment inside and outside a surgical target object, and adjusts the relative position between the virtual medical equipment object and the virtual surgical target object in the surgical situation 3-D model according to the calculated positions.

13. A training system for operating a medical equipment, comprising:
a medical equipment; and
the optical tracking system of claim 1 for the medical equipment.

14. The training system of claim 13, wherein the medical equipment comprises a medical detection tool and a surgical tool, and the virtual medical equipment object comprises a medical detection virtual tool and a surgical virtual tool.

15. The training system of claim 14, wherein the computing device evaluates according to a process of utilizing the medical detection virtual tool to find a detected object and an operation of the surgical virtual tool.

16. A calibration method of an optical tracking system for a medical equipment, comprising:
a sensing step for utilizing a plurality of optical sensors of the optical tracking system to optically sensing a plurality of optical markers of the optical tracking system disposed on the medical equipment so as to generate a plurality of sensing signals, respectively;
an initial calibration step for performing an initial calibration between a coordinate system of the optical sensors and a coordinate system of a surgical situation 3-D model according to the sensing signals so as to obtain an initial transform parameter;
an optimization step for optimizing degrees of freedom of the initial transform parameter to obtain an optimum transform parameter; and
a correcting step for correcting a configuration error of the optimum transform parameter caused by the optical markers.

17. The calibration method of claim 16, further comprising a pre-operation process, wherein the pre-operation process comprises:
calibrating the coordinate system of the optical sensors; and
adjusting a zooming scale of the medical equipment and a surgical target object.

18. The calibration method of claim 16, wherein the initial calibration step is performed by a method of singular value decomposition, triangle coordinate registration, or linear least square estimation.

19. The calibration method of claim 16, wherein:
the initial calibration step utilizes a method of singular value decomposition to find a transform matrix between characteristic points of a virtual medical equipment object of the surgical situation 3-D model and the optical sensors as the initial transform parameter, and the transform matrix comprises a covariance matrix and a rotation matrix; and
the optimization step obtains a plurality of Euler angles with multiple degrees of freedom from the rotation matrix and performs iterative optimization of parameters with multiple degrees of freedom by Gauss-Newton algorithm so as to obtain the optimum transform parameter.

20. The calibration method of claim 16, wherein:
positions of the virtual medical equipment object and a virtual surgical target object in the surgical situation 3-D model are set according to the optimum transform parameter and the sensing signals; and
the correcting step corrects the positions of the virtual medical equipment object and the virtual surgical target object in the surgical situation 3-D model according to a reverse transform and the sensing signals.
